(19) United States
(12) Patent Application Publication
(10) Pub. No.: US 2009/0248806 A1
(43) Pub. Date: Oct. 1, 2009

(54) System and method for dynamically changing item status in static email messages

(76) Inventor: Ari Teman, New York, NY (US)

Correspondence Address: BLANK ROME LLP, WATERGATE, 600 NEW HAMPSHIRE AVENUE, N.W., WASHINGTON, DC, 20037, US

(21) Appl. No.: 11/826,769

(22) Filed: Jul. 18, 2007

Related U.S. Application Data
(60) Provisional application No. 60/807,812, filed on Jul. 19, 2006.

(51) Int. Cl. G06F 15/16

(52) U.S. Cl. 709/206

(57) ABSTRACT

A system and method that allows dynamic updating of a static email message by maintaining the status of the content of the email message on a server and remotely serving images or stylesheets relaying the current status to a user's email client when the static email digest is displayed. Other applications of the system and method include, but are not limited to, updating the status of online message board postings contained in an email digest once the original poster has accomplished what was requested in the posting, so he will not subsequently be contacted about the post by users reading the email digest.

### CROSS-REFERENCE TO RELATED APPLICATIONS

The present application claims the benefit of U.S. Provisional Application No. 60/807,812, filed Jul. 19, 2006. The disclosure of that provisional application is hereby incorporated by reference in its entirety into the present disclosure.

### BACKGROUND OF THE INVENTION

1. Field of Invention

The present invention relates generally to the field of electronic mail using a networked communications system. More particularly, the invention relates to systems and methods for dynamically changing the status of items in an email digest or a notification email.

2. Description of Related Art

Mail digests are increasingly popular and well known in the art. Many portals, such as Yahoo!™, allow individuals and groups to setup virtual communities or groups where members of the community can post messages to a message board requesting information or action. These message boards enable growing virtual communities to stay tightly-knit, informed, and cooperative. Because these services, which are often free, provide such benefit to communities, it is common for a single message board to receive a few hundred messages a day. To allow members of the community to stay informed without having to visit the community web site several times a day, the service providers often send emails to members of the community with a digest of the messages posted to the board over an interval of time. Often, the community member or the service provider can customize the email digest service to send a digest of messages on a set interval, such as once per day, or after a certain number of messages have been posted to the board since the last digest was sent. On popular message boards, a user may receive several digests per day.

When a group has thousands of subscribers participating on the message boards throughout the day, however, a message requesting information or action may be answered immediately. If the message is sent out in a digest to users, however, the substance of the posting may be addressed by another user before most users have read the digest. Once the substance of the posting has been addressed by another member, however, there is no need for additional responses. For example if a user requested a babysitter, once a babysitter responds and is accepted the requesting user no longer needs to receive communications from other users offering babysitting services. Hours of useless calls are annoying and costly to all parties. As an additional example, if a user sees a posting in a digest offering an item for sale, she may assume the item is still for sale when in fact someone who read the post earlier already made the purchase. That is disappointing to the hopeful reader, and disrupting for the seller to have to field these later callers.

Similarly, notification email messages sent from community web sites or portals are also well known. On websites such as Facebook™ or MySpace™, notification emails are often sent to alert a user that he has received a new contact or some other event has occurred relating to his account. The user may then log on to the website to view the event. Sometimes, however, the user will have logged on to the website and viewed the event before reading the email notification. In such a case, the user no longer needs to view the notification and may, in fact, be confused by it, believing, for example, that an additional event has occurred.

What prior art email digest and email message systems and methods fail to address, however, among other things, is that email messages that have already been received are stored in static form and the sender cannot change the content of the digest or remove a posting from the subscriber's digests in response to a change in the status of a posting on the community. Thus, these postings remain in email digests already sent to users and any user reading the digest cannot tell whether these postings or notifications are void without logging on to the community website or finding out from a poster or email sender that they just wasted their time responding to a closed message. Systems and methods that allow for changes to be made to the status of a previously posted message, and that allow for an email digest of postings or notifications to display the current status of the contents of the email to the reader, regardless of when the digest was sent or when the posting status changed, would be highly desirable.

### SUMMARY AND OBJECTS OF THE INVENTION

It should be apparent that there exists a need for a system and method for dynamically changing the status of items in a static email message that allows a user viewing the message to identify the current status of items in the message instead of the status of the item at the time the email message was sent. There also exists a need for a system and method that can maintain the status of items such as postings or notifications to an online community message board in response to input from the poster or other authorized user of the online community.

Accordingly, a principal object of the present invention is to provide systems and methods for dynamically changing the status of an item in a static email message, by embedding instructions in the static email message for retrieving and displaying the current status of the item in the message.

It is another object of the invention to provide a system and method for dynamically changing the status of an item in a static email message, by maintaining the status of the items on a server in response to input from the originator of the item or other users of the online community having permission to update the status of the item.

It is still another object of the present invention to provide a system and method for updating the status of a posting made to an online community message board.

It is another object of the present invention to provide a system and method for maintaining a database of statuses of items to be emailed to users of an online community.

It is still another object of the present invention to provide a system and method for sending email digests that can dynamically update the status of the items digested.

It is another object of the present invention to provide a system and method for automatically hiding or highlighting items in an email digest that have been marked as addressed or irrelevant by the creator of the item or other authorized user.

It is still another object of the present invention to provide a system and method for remotely hosting on a server stylesheets for modifying and displaying email messages.

It is another object of the present invention to provide a system and method for remotely hosting on a server images indicating status.

Briefly described, those and other objects and features of the present invention are accomplished, as embodied and fully described herein, by a system for dynamically changing a static email message comprising one or more servers for maintaining an online community in data communication with one or more client computers of a plurality of subscribers to the community, the client computers adapted to enter and send a plurality of items to the servers and receive a plurality of emails from the servers, a database for storing the plurality of items and a status of the plurality of items, a status processing component for maintaining the status of the items in response to communication with the plurality of subscribers and an email processing component for creating a plurality of email messages containing one or more items and sending the email messages to the plurality of subscribers, the email messages containing or calling for a set of instructions for displaying on the client computers the status of the one or more items contained in the email messages as maintained by the status processing component.

The above objects and features of the present invention are accomplished, as embodied and fully described herein, by a method for dynamically changing a status of a posting in a static email message, comprising the steps of storing in a database at a server a plurality of items sent to a provider of an online service from a plurality of users of the online service, each of the items having a status indicating whether the item has been addressed by any of the users of the online service, updating the status of the items in response to communications with users of the online service having permission to update the status, creating an email message containing one or more items and embedded instructions for retrieving from the server the status of the included items, sending the email message to one or more users of the online service, and opening in a client computer of a recipient user the email message, executing the embedded instructions for retrieving from the server the status of the items contained therein and displaying the current status of the items on the client computer.

With those and other objects, advantages, and features of the invention that may become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a diagram of an example mail digest displaying inventive functionality;

FIG. 2 is another diagram of an example mail digest displaying inventive functionality;

FIG. 3 is diagram depicting the architecture of the system for dynamically changing the status of static email messages;

FIG. 4 is a block diagram of the system allowing the changing of status and notification of a change in status;

FIG. 5 is another block diagram of the system depicting the use of aliases to allow the changing of status and notification of a change in status;

FIG. 6 is another block diagram of the system depicting the use of script or program to allow the changing of status and notification of a change in status;

FIG. 7 is another block diagram of the system depicting the use of unique stylesheets per digest to hide or format messages or change the image source per image; and

FIG. 8 is another block diagram of components of the system;

FIG. 9 is another diagram depicting the architecture of the system for dynamically changing the status of static email messages;

FIG. 10 is a flow chart depicting the process of posting a message to a group board, moderating that message, generating statuses for the message, and then compiling that message and additional items into a digest, and finally emailing that digest to the recipient;

FIG. 11 is a flow chart depicting the process of a recipient's email client downloading and formatting the email message by downloading remote stylesheets;

FIG. 12 is a flow chart depicting the functionality of the toolbar extension;

FIG. 13 is a flow chart depicting the process of a user replying to a message, where they do not have the toolbar extension, via a web browser;

FIG. 14 is a flow chart depicting the process of parsing and updating an item in an email digest;

FIG. 15 is a flow chart depicting the updating of a single notification email;

FIG. 16 is a flow chart depicting the updating of a non-message item, such as an advertisement or event listing, which may be embedded into any email; and

FIG. 17 is a flow chart depicting the functionality of this invention for use with person-to-person(s) emailing through a mail server.

### DETAILED DESCRIPTION OF THE PREFERRED EMBODIMENT

Several preferred embodiments of the invention are described for illustrative purposes, it being understood that the invention may be embodied in other forms not specifically shown in the drawings.

I. System Architecture

Structure of the Static Email Messages

Once an email message is sent from a server to a recipient, that message cannot be changed by the sending server. Therefore, messages are static text sitting in the client's mailbox. This invention modifies the static email message by requiring calls for remote images and/or stylesheets and also by requiring each posting to be encased in tags identifying the posting and categories so a stylesheet can define the style of each posting and the style of each category. Additionally, email client extensions 802 described below can parse the email messages using these tags so it can format, filter, and search the email according to a user's preferences.

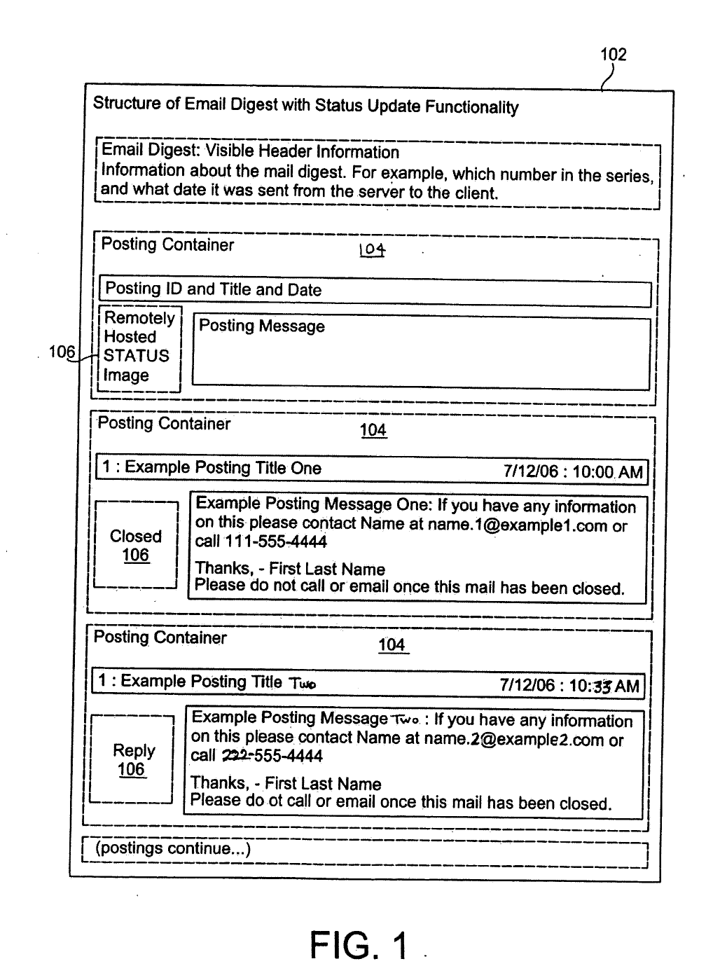

Turning first to FIG. 1, shown therein is an example layout of a dynamically updating email digest 102 where a remotely hosted status image 106 is placed at the side of each posting 104 noting the status of the posting 104. The image 106 must be clicked to reply to a message so a user will not reply to a closed message.

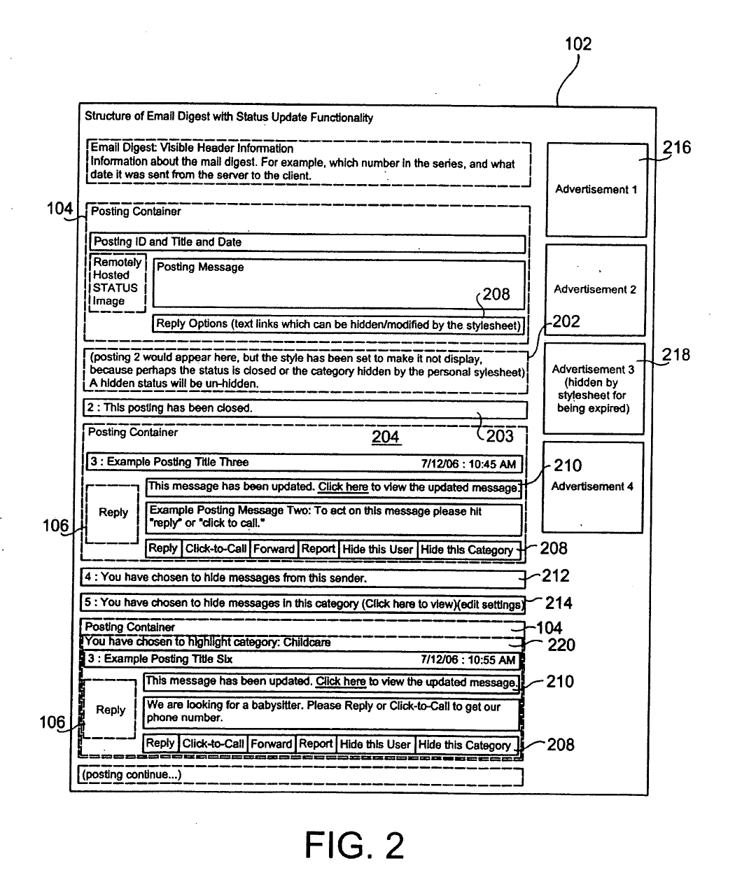

FIG. 2 shows another example of a dynamically updating email digest 102 where a remotely served stylesheet is called changing the color, pattern, or font of a posting 104 to show it is void, open or featured or another status. The stylesheet also calls the correct status image 106 if desired. In this embodiment, a closed posting 202 is not displayed. Additionally, a previously hidden div for that posting, displaying a status 203, is now unhidden and displaying the current status to the user.

A “div” HTML tag defines a division or section of a document. It may contain other divs, text, images, and other HTML content, and it may also be empty. Each div may have its own ID or Class or it may share a class. For example “<div class=header_{—}1>Header for Posting One</div>” might define the section which is the header or title for posting one. Using a stylesheet or a style tag the style of all divs with a class of “header_{—}1” could be defined. Additionally, a div may have multiple classes assigned to it, such as “<div class=‘generic_header header1’>Header for Posting One</div>.” Here, the tag ‘generic_header’ would apply the standard style that is defined for all divs with the class generic_header, and then the tag ‘header_{—}1’ would further define the style for that specific header. For example, all ‘generic_header’ divs might be displayed as bold with a blue background, but ‘header_{—}1’ might also have its text italicized for emphasis. Thus, the div would first be set to bold with a blue background, and then the text would be italicized. Further, a class can be set to not display. This is useful for hiding outdated information, as well as hiding information until it is relevant.

The functionality of this method is not limited specifically to ‘div’ tags. In fact, almost any HTML tag can be completely redefined from it's traditional use by a stylesheet. Therefore such tags as ‘span’, ‘p’ (which usually defines a paragraph), or ‘ul’ and ‘li’ (which usually define items in a bulleted list) are often used for the same purpose as a div tag. Additionally, HTML parsers may allow you to create a novel tag, one not previously defined by HTML, and then define its style via a stylesheet or style tag. A style tag is when the style of an item is embedded right into the tag. For example, “<div style=‘font-weight:bold;’>content of div</div>” would make the text “content of div’ bold. One benefit to this flexibility is that the same document can be customized to different displays, and for different user preferences or vision impairments. While every HTML parser follows its own rules, general guidelines for HTML and related languages such as XHTML and XML are published by the World Wide Web Consortium (“W3C”).

The next posting 204 shows a message that has been updated after the digest 102 was sent out. A status message 210 is unhidden according to the stylesheet alerting the reader that there is an updated version which they can read online. Because the system can also download or embed a personal stylesheet which overrides the global and per-digest styles, the user can hide messages from specific senders 212 or categories 214. The user may also choose to highlight 220 a category. The stylesheet may be used to highlight a posting as a sponsored posting, in the per-digest message. On the right, the stylesheet is used to hide an advertisement 218 which was embedded into the email but is now expired, perhaps because the advertiser is no longer paying.

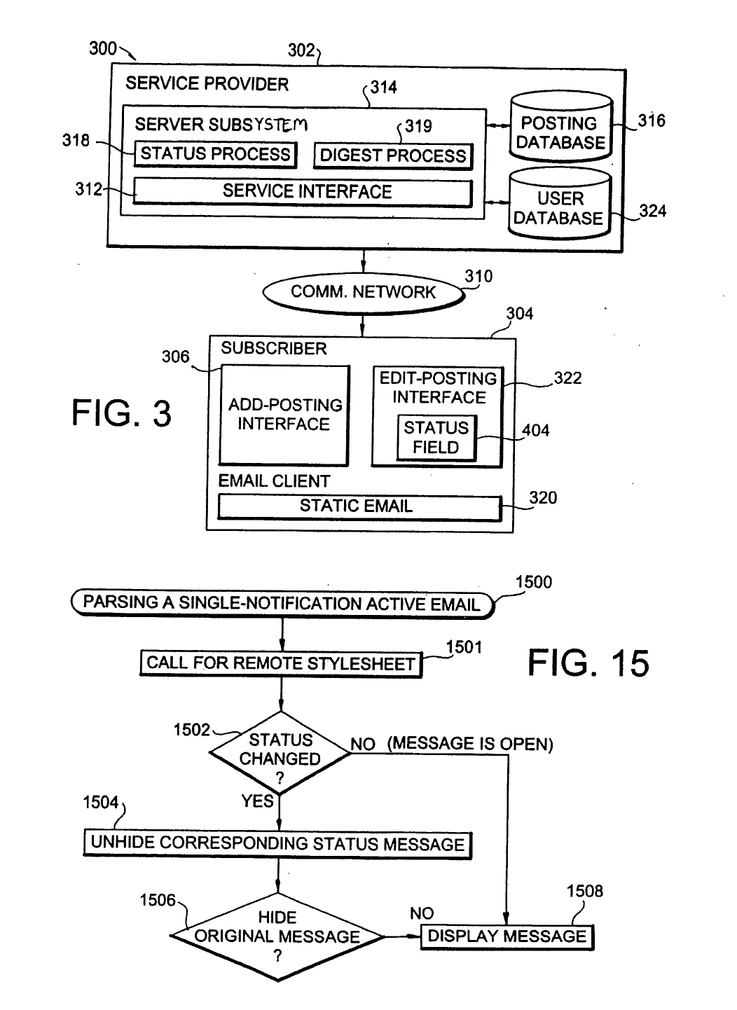

FIG. 3 is a drawing depicting a schematic of the system architecture of a dynamic email system 300 according to one aspect of the present invention. For purposes of illustrating the invention, the system 300 will be discussed in connection with a message board email digest program; however, it should be noted that the system 300 could easily be employed in any email system in which static emails are to be dynamically updated after having been sent, such as for emails with a single notification which prompts the recipient for action.

The system 300 includes a service provider 302 and a plurality of subscribers 304. The invention contemplates that a subscriber 304 will submit a new posting to the service provider 302 using an add posting interface 306 in data communication over a communications network 310 with a service interface 312 in a server subsystem 314 of the service provider 302. The posting may be saved by the server system 314 to a database 316. A status process 318 will mark the posting as “open” as necessary to indicate that the subject of the posting has yet to be addressed.

A digest process 319 in the server subsystem 302 will periodically compile an email digest of the postings that have been received by the system 300 since the last digest. The interval at which an email digest is created can be determined by the service provider or the subscriber receiving the email digest. The service provider or subscriber can elect to have a digest created following the passing of a certain period of time, the receiving by the system of a certain number of postings, or some other criteria. When the digest is compiled, it is sent to the subscriber 304 over the communications network 310. When the subscriber 304 opens the email digest at any time in an email client 320, embedded instructions in the email message retrieve the current status of a posting as maintained in the posting database 316 by the status process 318. This can be accomplished by downloading a remotely hosted status image or stylesheet. The subscriber 304 is then able to tell whether a particular posting in the email digest has current status of open, closed, void, or some other status.

The service provider 302 is capable of interfacing with one or more databases 316 as shown in FIG. 3. The database 316 could be, for example, a database containing items and the status of items. Items could be, for example, message board postings, emails, invitations to join an online community, online forum postings, messages sent via private messaging, or community profile page postings. Statuses could be, for example, “open,” “closed,” “featured,” or “void.”

As shown in FIG. 3, the service provider 302 and the subscriber 304 are connected to a data communications network 310. The particular connectivity of the service provider 302 and the subscriber 304 is for illustrative purposes only. The network 310 may be, for example, a wireless network used by mobile computing devices like cellular telephones, the Internet, an intranet, or some other network system. Preferably, the network 310 is a packet-switched network capable of routing hypertext, extensible, or other types of markup language code and data in accordance with the standard Internet Protocol or some other protocol in order to generate web pages. The Internet Engineering Task Force is the standards body that creates and maintains the basic standards on which the Internet depends, including the Internet Protocol specification published in 1981.

The service provider 302 maintains a server subsystem 314, which can include one or more server computers that are adapted to, among other things, store and process data, generate responses to subscriber requests for markup language files and information, and maintain online communities. Subscribers 304 can use one or more interfaces 306, 322 to access the server subsystem 314, preferably via a web site graphical user interface that is generated on the subscriber client 304 using markup language commands and data provided to those devices by the server subsystem 314.

An add posting interface 306 allows the user to add a posting the online community. The status system 318 assigns all new messages the default of “open.” The posting and the status are stored in the database 316. The posting will be added to the next email digest according to the rules of the service provider 302 and the subscribers 304. The add posting interface 306 can be a standard Internet-based form.

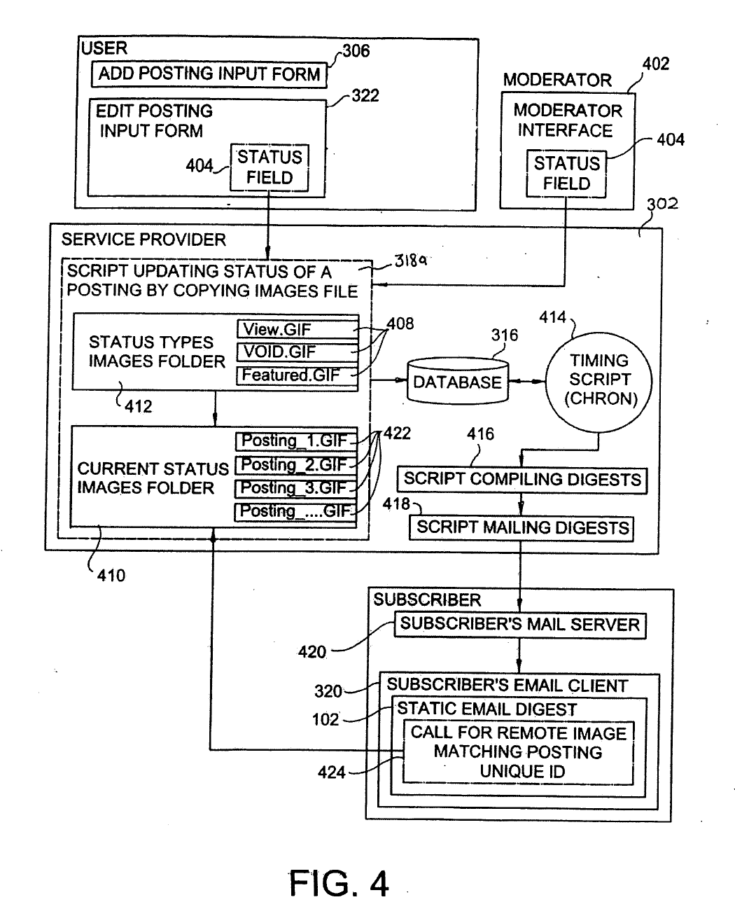

An edit posting interface 322 allows a poster to change the status of his posting. For example a posting with a request that has been fulfilled may be set to “closed” by the requesting poster using a status entry field 404 in the edit posting interface 322, as shown in FIG. 4. The status process 318 will update the status associated with posting in the posting database 316. Subsequently, any subscribers 304 viewing an email digest containing the posting will have the current status of the posting displayed in their email client 320. Displaying this information will prevent readers of the digest from calling, messaging, or emailing the poster needlessly. The edit posting interface 322 can be a standard Internet-based form.

Moderator Interface

Some online communities allow moderation by group leaders. In that case, as shown in FIG. 4, after the posting is stored in the database 316 it is sent to the moderator who can edit it and set its status using a status entry field 404 in a moderator interface 402. When the moderator sets a new status in the status entry field 404, the status process 318 will then update the status associated with the posting stored in the database 316. A moderator can close an item on a poster's behalf or feature an item, such as one from or related to a group sponsor.

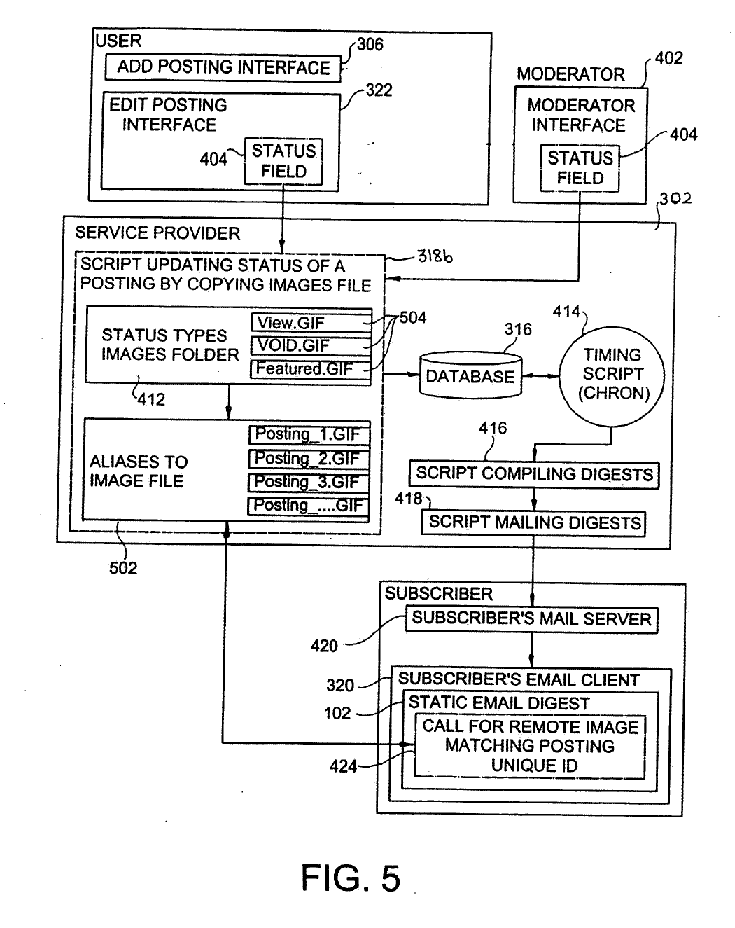

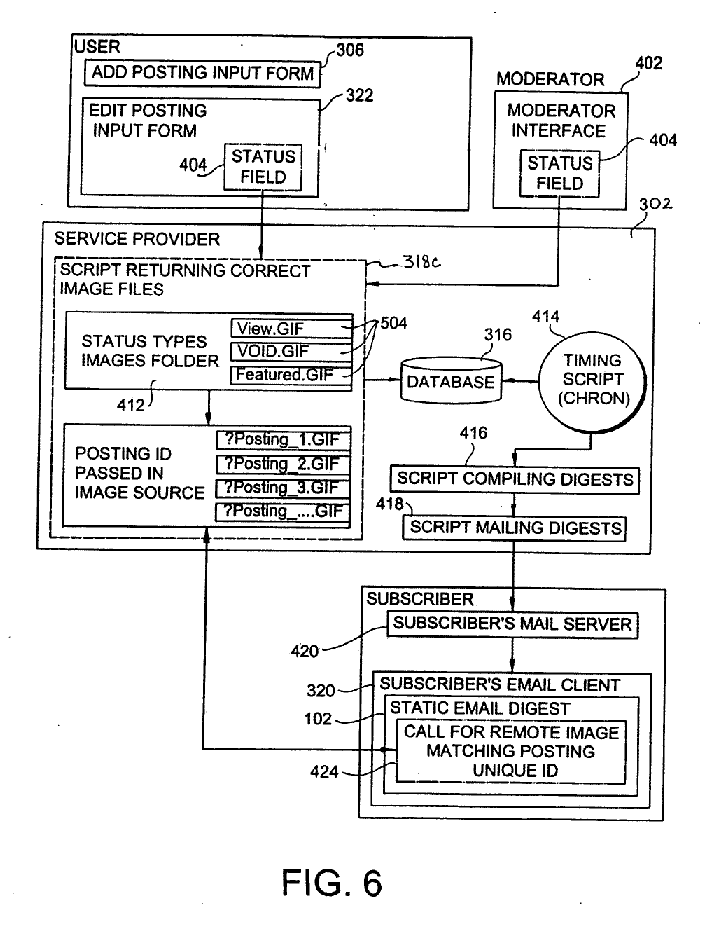

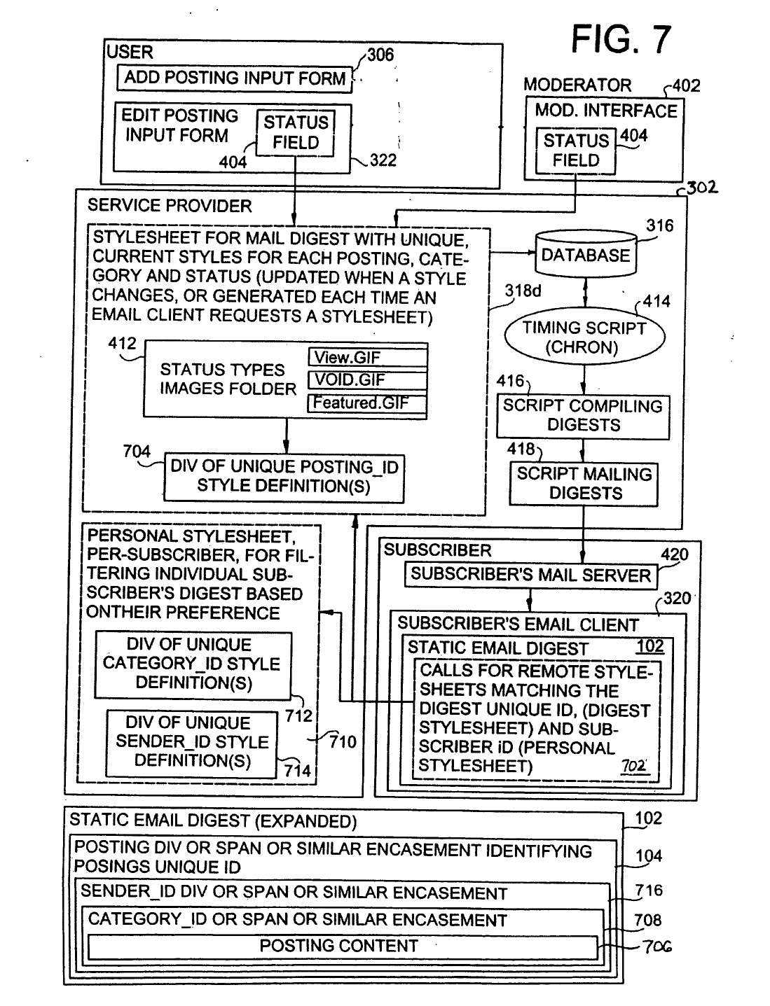

This status process 318 can work in multiple methods depending on the desires of the service provider 302. For example, it can copy the status image and assign it a name matching the ID of the new posting as shown by the status process 318a in FIG. 4. Alternatively, it can update an Alias file 502 as shown by the status process 318b in FIG. 5. In still another alternative, the status process 318c can return the correct image data in response to a direct call by the subscriber's email client 320 as shown in FIG. 6. In another alternative, the status process 318d can return a stylesheet that defines, according to the current status of the postings, how the postings in the email digest should be displayed as shown in FIG. 7. The status process 318 may be coded in any combination of languages that can interact with existing email digests.

Remotely Hosted Images

Turning to FIG. 4, a static email message 102 may call for remotely hosted images 106. In HTML this would be done with a call such as, for example, “<IMG SRC=“http://internet.address/image.folder/image.file”>.” Because this image 106 is remote it can be modified by the status process 318 on the sending server 314, using, for example, server-side scripts. When the status of a posting is updated by a user using the edit posting interface 322 or a moderator using the moderator interface 402, that status process 318a copies a corresponding image 408 from a status types images directory 412 into the current status image directory 410. The image file copied is renamed to the file name expected by an email digest containing the posting and overwrites the image 422 currently in the current status image directory 410. For example void.gif 408 is renamed to posting_{—}2.gif 422 and overwrites the file currently stored as posting_{—}2.gif 422.

At any point, an email digest 102 of postings currently received by the message board system may be created 416 and sent 418 to users of the online community. This invention does not modify the way email digests are sent to users. Usually these are sent after a certain amount of time 414 or number of new postings has accumulated for a specific message or news board. The message is compiled 416 and mailed 418 to each subscriber's mailbox 420 where it sits until it is called by the subscriber's email client 320. The email client 320 reads it as a static email message 102 but can load images 422 stored remotely by the service provider 302 in the current status images folder 410. By calling to the remotely stored images 422, the static email message 102 can be dynamically updated with the status of the postings contained therein. As a result, the status can be set by a posting user through the add posting interface 306 or the edit posting interface 322, by a moderator using the moderator interface 402, or by another authorized user before, during or after the email digest 102 is sent. The email digest 102 will update with the most current status of the postings whenever the email digest 102 is displayed because the status is not stored in the static email 102 itself.

Remotely Hosted Alias Instructions

Instead of copying each image for each posting as it is updated as shown in FIG. 4 or calling and running a script for each image as shown below in FIG. 6, the service provider may prefer simply to alias all remote images per a single status call to a single image for that status, as shown in FIG. 5. For example, when an email client 320 requests a remote image 102 for posting 123, the server 314 knows by looking at its alias file 502 that Posting_{—}123.gif really points to VOID.gif 504 in the status types images folder 412 and returns the image 504 showing the status of posting 123 as void. Calling an alias can be much less taxing on a server than running a script as shown in FIG. 6 or copying each image so each posting has one corresponding status image as shown in FIG. 4.

Calling the Status Script Directly as the Remotely Hosted Image

Turning now to FIG. 6, the status process 318c is called directly by the static email message 102 from the subscriber's email client 320 and returns the correct image data. For example, a call to the status process 318c by the email client 320 as shown in FIG. 6 reveals that posting 1 and posting 2 are still active, but posting 3 is void. Because the status process 318c is being called directly it can return a custom image each time it is called. That enables the status process 318c to return custom data based on the preferences of the particular user viewing the email digest 102. That might be used to show messages as Void or Featured to certain IP addresses or user IDs if the user ID is passed in the remote call 424. The status process 318c might also send data for that posting giving an indication to the viewing user that he is the author of the posting by, for example, displaying a button saying “Edit Your Posting.”

Remotely Hosted Stylesheet

Alternatively or additionally, the static email message 102 may call for a remotely hosted stylesheet 318d. A stylesheet is a set of computer instructions used to describe the presentation of electronic documents. Stylesheets may be embedded into a document or may be separate documents called remotely by the document. An HTML, or similar, document can use multiple stylesheets, and may even combine locations of the stylesheets, with some embedded into the HTML document and others called remotely. If a style is defined twice, within a single stylesheet or across multiple stylesheets, the latest line to be parsed overrules earlier definitions. For example, if style “headline1” is defined with its color set to blue in a first stylesheet, and then the document includes a second stylesheet where “headline1” is defined with its color set to red, all items with the style “headline1” will be colored red.

Embedded in the static email message 102 is a call 702 to a remotely hosted stylesheet 318d. Just as a remotely hosted image 422 or alias file 502 can be edited by the status process 318, so can the stylesheet 318d in response to changes in the status made by an authorized user. Therefore when the user goes to view the email message 102 in his email client 320, the email client 320 will download the most recent stylesheet 318d. This stylesheet 318d will define unique styles 704 for each posting 104 in the email digest 102. The stylesheet 318d may be used to hide an entire posting 202 or reformat a featured posting 204 as shown in FIG. 2.

Remotely Hosted Custom Stylesheet Per User

Each user can specify senders and categories of messages they would like not to see. All postings 706 are encased in tags defining their sender ID and category ID 708. That encasement can be a tag such as a DIV or SPAN which specifies a class of style 704 for that posting. The user's custom stylesheet 710 sets all tags with that ID to display in a desired way or to not display at all. The same can be done to highlight favorite categories. For example, a user who does not want to see ads for babysitters can specify his stylesheet 710 to hide all messages encased in a DIV or SPAN or other tag with a class or ID equal to that of childcare. If the same user prefers to see all messages related to cars, he can set his stylesheet 710, via a web interface, to highlight all messages encased in that category ID 708.

Unique Encasement of Category with Defined Style

A user may have his own stylesheet 710 dictating which categories to display and how to display them 712. The stylesheet may also hide or highlight messages by a certain sender ID 714. The category encasement 708 triggers that category's style 712 from the user's stylesheet 710 which is stored on the service provider's 302 database 324 or in a folder on the server 314. Similarly, the sender encasement 716 triggers the style that the recipient has set 714 for the sender.

Email Client Extension to Integrate with Status System

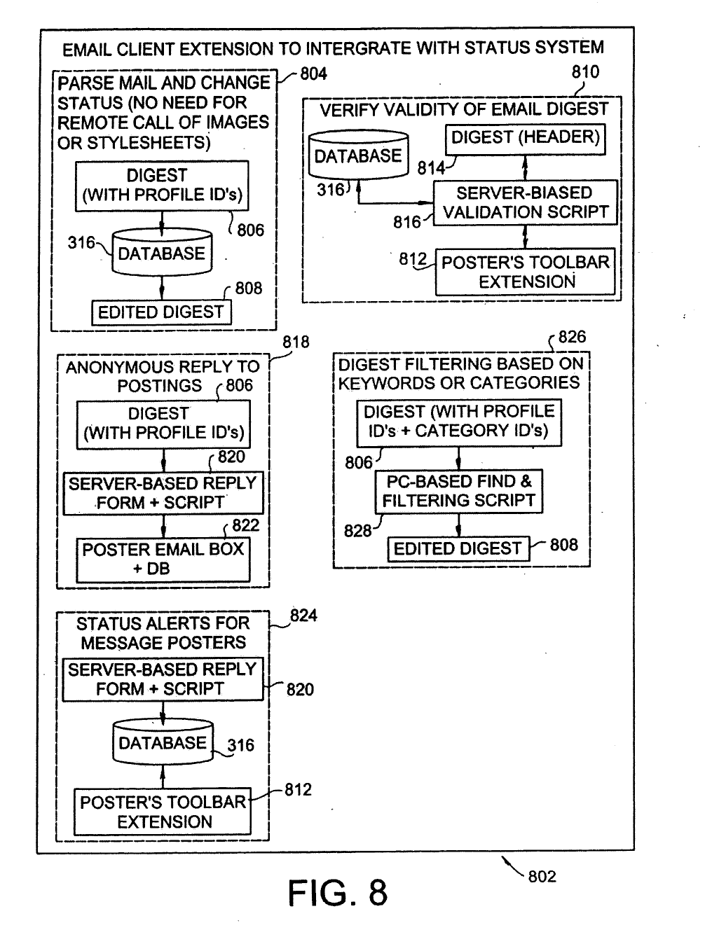

Turning now to FIG. 8, the email client extension 802 adds more robust status features to the status system described herein. While what has been described so far is enough to prevent hassle and harassment for millions of users, these features allow highly active users access to their data more quickly. It also protects all users against fraudulent copies of the mail digests which may seek private information from unsuspecting users, a technique commonly known as “email phishing.”

Function of Email Client Extension to Parse Mail and Change Status

The parsing process function 804 of the client extension 802 parses the static email digest 806 and checks the database 316 on the server 314 to see the status of each posting in the static email digest 806. The parsing process 804 then modifies the digest 806 on the local computer or user's mailbox to create an edited digest 808 that displays the current status of each posting. That edited digest 808 will contain only relevant postings or news items. That allows for functionality in secure situations where a user cannot download any image or stylesheet files which may be blocked by firewalls or otherwise prohibited.

Function to Verify the Validity of Email Digest

A malicious programmer may attempt to send a fake digest hoping that users will respond to postings with private information. For example, someone who believes they are responding to a neighbor or co-worker's posting may reveal private addresses or history. The function to verify the validity of an email digest 810 activates an icon on the tool bar 812 and will alert the subscriber 304 that the message in question is fake and hide its contents until the subscriber 304 acknowledges the warning.

Because email digests and notification emails are generated or sent through a server 314, the server 314 will have in a database 316 an exact copy of the message, allowing a comparison 816 of the recipient's local copy of the message to the copy on the server 314. While the module can and should also compare the IP addresses recorded in the message header 814 to those of the server 314 from which the mail was sent, this is inferior to comparing the entire content of the message, including the header 814, because the IP address sent to the recipient may be forged. Comparing the entire content of the messages, however, would cause a false match and activate the warning from the toolbar 812 with even one false link.

To save time, the module 810 may compare 816 only links, image tag source locations, and URLs, which are what is usually used to direct users to fake, ‘phishing’ websites which are then used to steal private information.

Function to Allow Anonymous Correspondence Between Subscribers

A poster may want to ask an anonymous question or a responder may not want to share their identification. The function to allow anonymous correspondence 818 enables both users to remain anonymous by using a script 820 which knows both ID's to send mail between users.

Currently, many digests, bulletin boards, and service providers enable the sender of a message to anonymize their email address. For example, the service will facilitate a response to message number 12345 by publishing the email address message12345@example.com in the posting. The server would then forward those replies to the true email address belonging to the sender of message 12345. This does not, however, facilitate an anonymous reply from the responder. If a recipient replies from their mail client, their email address is transmitted in the From address. The anonymous correspondence function 818 of the toolbar extension 802 would communicate with the service provider's 302 server 314 to facilitate this functionality. When a responder responds to a posting in a digest, 806 a request 820 for an anonymous email address is made that would link to this message and responder, such as responder78910@example.com. The response is then sent to the poster of the message using that anonymous email. Further, because the server 314 knows the true email of the responder, a moderator may still block a user from sending anonymous messages to prevent abuse.

Function to Filter Digests Based on Categories or Keywords

While the per-user stylesheet functionality allows users to filter mail based on category, this filter digest feature 826 allows them to do this instantly, without needing to revisit the service provider's 302 service interface 312. They can also filter digests based on keyword.

While the server-based personal stylesheets are able to filter messages based on tags such as those identifying the sender ID or category ID, it may be impractical to place a tag for each word in every posting. In such a situation, keyword-based filtering can be done when the recipient activates it in real-time. The toolbar module 802 would be able to find a word in the document. While that is a function included already in most email clients, this extension would recognize in a digest 806 using a PC-based script 828 which were the opening and closing tags of each posting. The resulting edited digest 808 will hide and display postings according to a search done by the recipient with their toolbar 812. Thus, only relevant postings would be displayed or highlighted and the recipient doing the search would not have to scroll through useless information.

Function to Alert Posters to New Messages (Not Shown)

A script on the server 820 sends a message to the user's toolbar 812, or makes the status viewable in a database to alert the user that they have responses to their posting. In that way, a poster can choose not to receive individual responses in his mailbox, but go online to view them all at once.

Because the toolbar 812 would have the user ID assigned to the user by the service provider 302, it would be able to frequently check the status of open postings made by that user by communicating directly with the server 314. While the toolbar 812 is open on the user's computer or within their email client 320, it would constantly ping the server which would notify the service provider 302 that the user's toolbar 812 was still functioning and therefore status updates could be displayed via the toolbar 812, rather than having the server 314 generate and send additional mails 218. This would cut down on the number of notification emails required and thus reduce the bandwidth and computing power employed. It would also ensure that the user does not have to constantly open or view their inbox to see what new messages have come in.

Because the toolbar 812 can display the number of messages and number of responses, the user can decide whether to login to the website to check those responses or wait for more responses. For example, if the user was looking to get a consensus of opinions in response to his posting, he could wait until his posting had received multiple responses before logging in, as indicated by the toolbar 812. Further, if a user receives hundreds of responses to a posting, rather than getting hundreds of notification emails in his inbox, a simple number could be displayed on the toolbar 812, thus saving him from having to delete or move those hundreds of notification emails.

PC-Based Filtering Script

The PC-based script 828 filters the mail digests 806 without action from the remote server 314, displaying only the postings matching the subscriber's 304 settings in an edited digest 808. If it connects to the remote server 314 it can filter out closed or voided messages and even edit the content of edited messages.

Server-Based Reply Form and Script

In the status alerts for message posters function 824 of the email client extension, a server-based reply form and script 820 handles all replies and updates to postings. The script is called to activate status changes. For example, when the script is called within a reply form, the poster is notified via his email client extension 812 on a toolbar via an icon that he has received a response to a posting. He could them click the icon for more information and to view the responses. The script 820 reads and updates the server databases 316. The reply form can be displayed by the email client extension 812 without opening an outside browser window. That makes it easy to give an immediate response from the email, without sending mail from a private email address, guaranteeing anonymity.

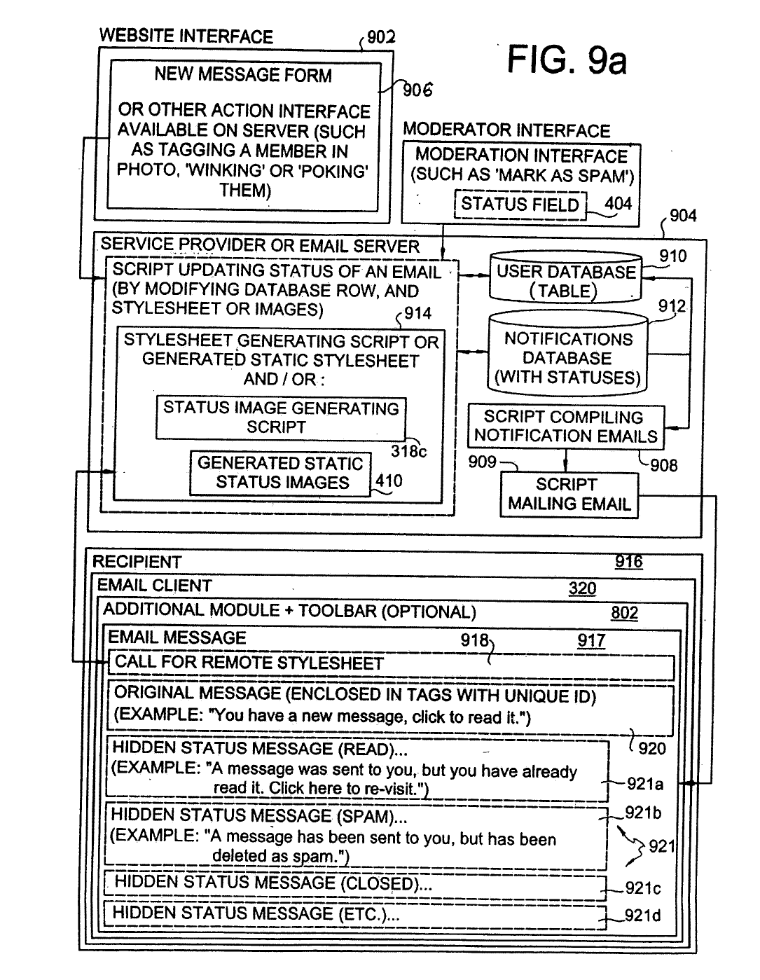

Turning now to FIG. 9a, an alternative single notification email 917 is depicted instead of the previously described email digest. Millions of these single notification emails 917 are sent every day by member-based community services such as MySpace™, Facebook™ and other community and dating websites. Often, these notification emails 917 alert 920 a user that a message has been sent to their user account on the community website and that it can be retrieved by logging in to the site. In this embodiment, the email 917 is alerting 920 a recipient 916 that another user 902 has sent him a message. However, the recipient 916 may have been logged in to the community website 904 when the message was sent by the other user 902 and may have already read the message before checking his email 320 and receiving the notification 917. Therefore the notification 917 is unnecessary and the recipient may return to the site expecting to see a new message from the sender 904 and be disappointed to find there is nothing new.

In order to avoid this, using the same functionality previously described for the email digest, a remote stylesheet 914 is called 918 for this message 917 displaying the correct status 921a, 921b, 921c, 921d of the notification message 920. For example, a user 902 sends 906 a message to the user/recipient 916 on the community website 904. The community website 904 generates 908 a notification email 917 to be sent to the recipient 916 to alert him that a message from another user 902 is waiting for him on the community website 904. The notification 917 is sent to the recipient 916 and a user database 910 and a notifications database 912 are updated to reflect that another user 902 has sent a message 906 to the user/recipient 916 and that a notification email 917 was sent to the user/recipient 916 alerting him of this 920. The notifications database 912 maintains the status of the notification. If the user was logged into the community website 904 when the other user 902 sent him a message, the notifications database 912 would be updated to reflect that the user 916 has already read this message. When the user 916 later opens the notification email 917 sent by the notification email generator 908, the email 917 will call 918 for the remotely hosted stylesheet 914 to determine how to display the notification email 917. The stylesheet 914 will reflect that the notifications database 912 indicates that the message has already been read by the user/recipient 916 and the email notification 917 will be displayed accordingly 921. Because there is only a single mail 917 being sent to one or a few recipients 916, in one embodiment, the stylesheet may be generated 914 dynamically when requested 918 by the client 320 and not before.

The notification can be marked with other statuses telling the recipient the message had been marked as spam 921b, deleted 921c, or other useful statuses 921d, which perhaps the original sender 902 can define, thus saving the recipient 916a useless trip to the website 904.

Additionally, when the server 904 receives the call 918 for the stylesheet 914, it knows that email 917 has been downloaded by the email client 320 and can notify the sender 902 that their message has been received. This is commonly done by mass mailings and email digests and would give individuals a more reliable read-receipt system.

Besides community websites, in another embodiment, the present invention can be used for person-to-person emails, by individuals who send email, as shown in FIG. 9b. A module which could be added to an existing email server 955, such as Sendmail™ or Exchange™ or offered as part of a new email server, would embed calls 970 to remote stylesheets 964 into the tops of all emails 967 sent, and enable the senders to update 954 those stylesheets 964. The stylesheets 964 could be actual text documents or simply a link to a script which returns styles based on the message ID.

For example, for each email 967 a user sends, the server digest process 318d will embed into the email message 967 a stylesheet 968 containing some pre-set or default statuses 981a, 981b, 981c, 981d and a call 970 to a remote stylesheet 964. If the sender 952 needs to update the message, or feels that the message is now outdated, the sender 952 can update 404 the status of that message via a web-based control panel or compatible toolbar 954, and the updated status would display when the recipient 966 opens that message 967 in their email client 320. Once the call 970 for the remote stylesheet 964 is made, a stylesheet script can update the database 960 to reflect that the message has been read, which may be useful to the sender 952. This enables the same functionality described previously to be used by individual email senders 952. Example statuses 981 which would be useful for emails are, ‘the sender is asking you to disregard this email,’ 981a ‘the sender has re-sent an updated version of this email,’ 981b ‘the sender says this email's content is expired’, ‘you have responded to this email’, ‘someone else has responded to this email’.

II. System Operation.

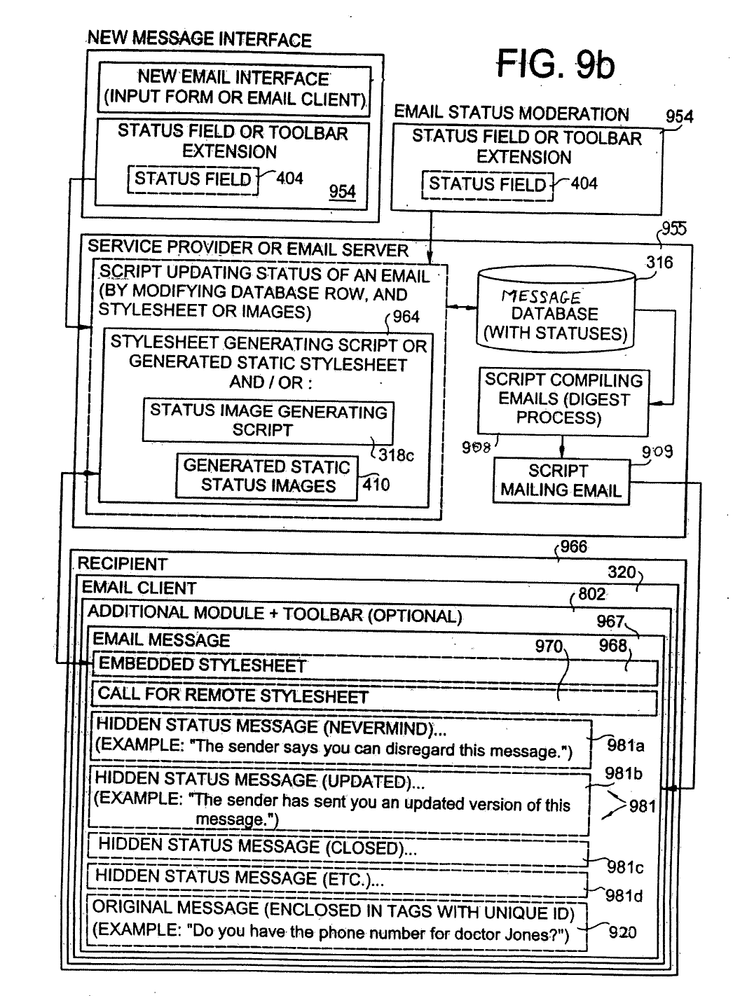

FIG. 10 is a process flow diagram depicting the server-side process flow steps according to an embodiment of the present invention. A poster posts a message to the group 1002 and the system assigns that message a Unique ID 1004. If messages require approval 1006 from a moderator, the moderator will have to review the posting 1008 and approve the message 1010. If not approved 1012, a rejection message is sent to the poster. If approved 1014, the message is activated 1014 and listed on the group or community website or feed 1016. Once there are sufficient postings or a certain time limit has been reached 1018 the server will compile an email digest 1022. The system compiles each message 1022 with each item tagged with its own unique ID, including any items which are in addition to digest postings. For example, these additional items may be advertisements 1024 or upcoming events 1028 from the group calendar. Embedded advertising 1026 and embedded events 1030 both can have expiration dates and the system will be able to update the remote stylesheets to hide expired items. It is also possible that the digest will embed hidden Advertising and hidden Events which it will unhide when the original items become expired, thus enabling more relevant information.

The system will then embed a global stylesheet 1032 and a link to a remote per-digest stylesheet 1034 which can overrule, and thus update the embedded global stylesheet 1032. It is recommended to embed at least part of the global stylesheet 1032 in case the email client fails to download any stylesheets. If the service provider enables each recipient to customize their digests 1036, it will also embed a link to their personalized stylesheet 1038. It then emails a copy of the digest to each group member 1040, the recipients.

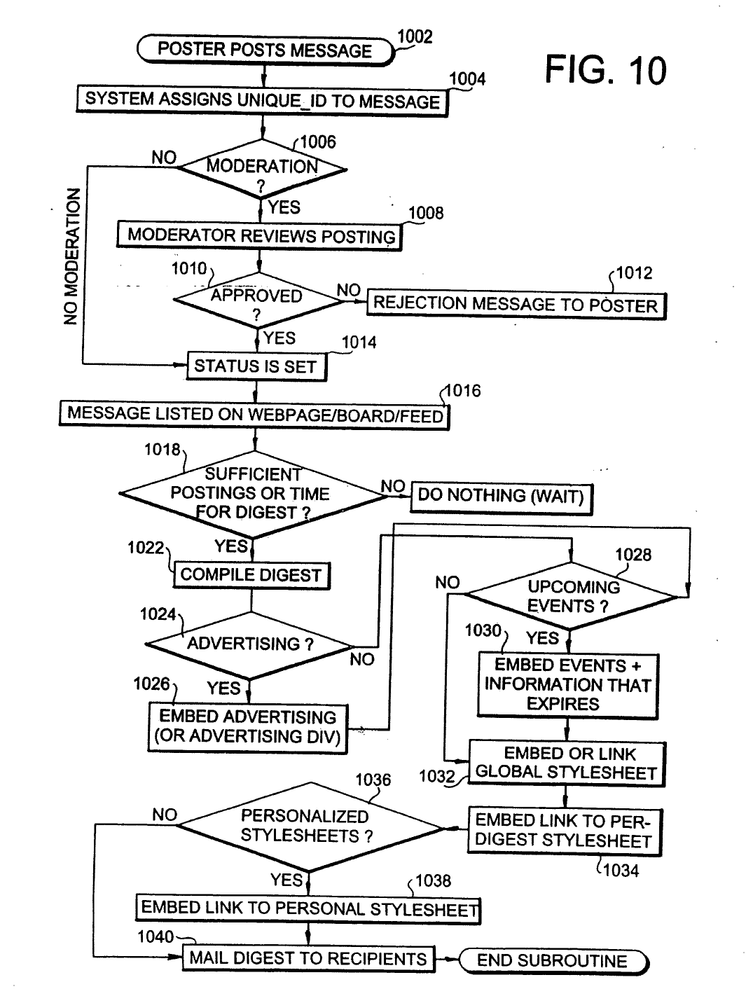

FIG. 11 is a process flow diagram depicting the client-side process flow steps according to an embodiment of the present invention. The recipient's email client downloads the email digest from the mail server 1102. The client will then parse the document and first act upon the embedded or linked global stylesheet 1104 which defines the styles for everything in that digest. That is a static, non-updated stylesheet. The digest code then has the client download a remote stylesheet 1106 that will update the items in that stylesheet, such as each posting and any advertisements, events and other items needing updating. If the stylesheet does not download properly 1108, a Download Failed note will be visible to the user 1110. Otherwise, the Download Failed note will be hidden 1112. Additionally the per-digest styleheet will update all items 1112, hiding closed messages, unhiding current status messages, hiding expired items, and unhiding newly current items. If a link to a remote personalized stylesheet has been embedded 1114, the system will download the personalized stylesheet 1116. If the download fails 1118 a notice will remain visible showing that the message has not been personalized because the download failed 1120. Otherwise, if the download was successful 1118 it will overrule the styles defined by the global and per-digest stylesheets 1122, highlighting or hiding messages based on sender and category.

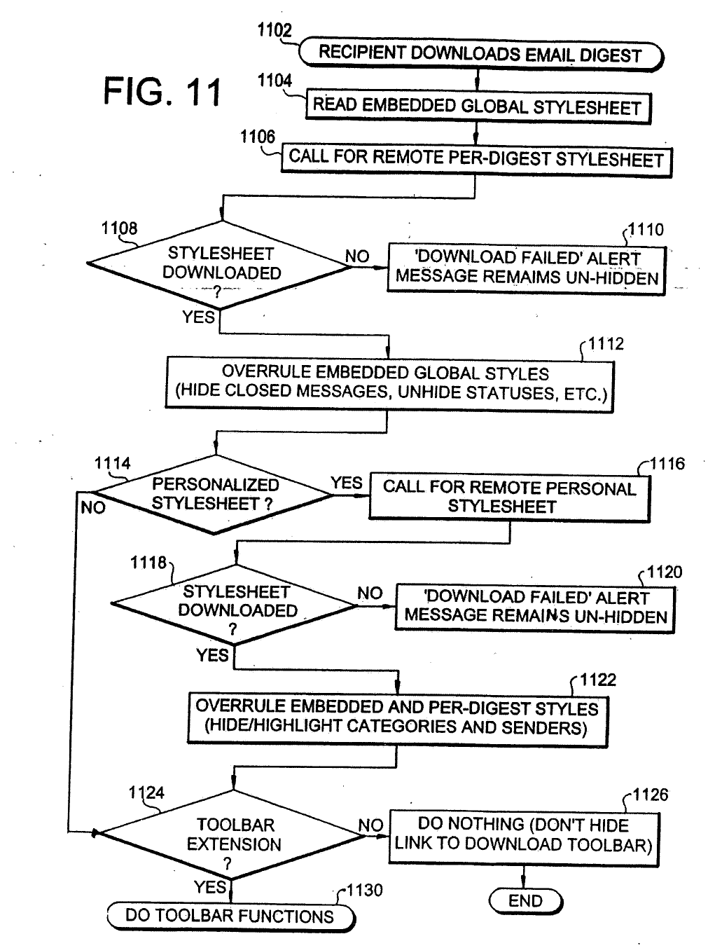

If the user has the toolbar extension installed 1124, the toolbar will then re-parse the document and perform additional updates and functions 1130 (see FIG. 12). Otherwise, a link may remain visible 1126 in the digest alerting the user that such a toolbar extension is available.

FIG. 12 is a process flow diagram depicting the client-side process flow steps according to an embodiment of the present invention where the user has the additional toolbar module. In this embodiment, when the email client downloads a message, the toolbar will parse the message 1202 and first verify the message is authentic 1204. If the message fails the authenticity test 1206, meaning it does not match the copy of the digest on the server, or variables which define that digest (perhaps it was sent by a spammer to ‘phish’ for personal information) the toolbar will hide the contents of the email digest and warn the recipient that it is a fraudulent copy 1208. If it is authentic 1210, each posting will be examined 1212 to check if the posting's status is still open 1214. If the posting has been closed it will hide the posting 1216. In this case the toolbar can check with the system's database, and it would not matter if the per-digest stylesheet had been updated yet. If the posting has been updated 1218 it can display the updated posting 1222. (Whereas recipients without the toolbar will only see a notice that the message has been updated, those will the toolbar will see the current version, as the toolbar can update the text of the email.) Otherwise, the original posting will be displayed 1220. If there have been replies to the posting 1224, the toolbar can download and display the number of replies in the notification 1226, and if the replies are public 1228 it can display them 1232 under each message in the digest, thus the recipient does not have to visit a website or click any links to view the current information.

Should the recipient click to reply to a message 1234, whereas a user without the toolbar would have to reply via a form in a page in a web browser 1306, the toolbar can open a form 1240 for the user to reply directly in the email client, and the toolbar will handle the reply. If the responder wishes to reply anonymously and this is allowed by the group 1236, the toolbar will assign an anonymous name or email address 1238, such as ‘responder12345@example.com’ to the responder. It will then show the reply form 1240. When the responder submits the form, the server will add the reply to the database 1242. If it is a public reply, and if it is the first public reply to the message 1244, the per-digest stylesheet can be updated 1246 to reflect that this message has been updated. The poster of the message is then notified 1248 that a response has been made to the message.

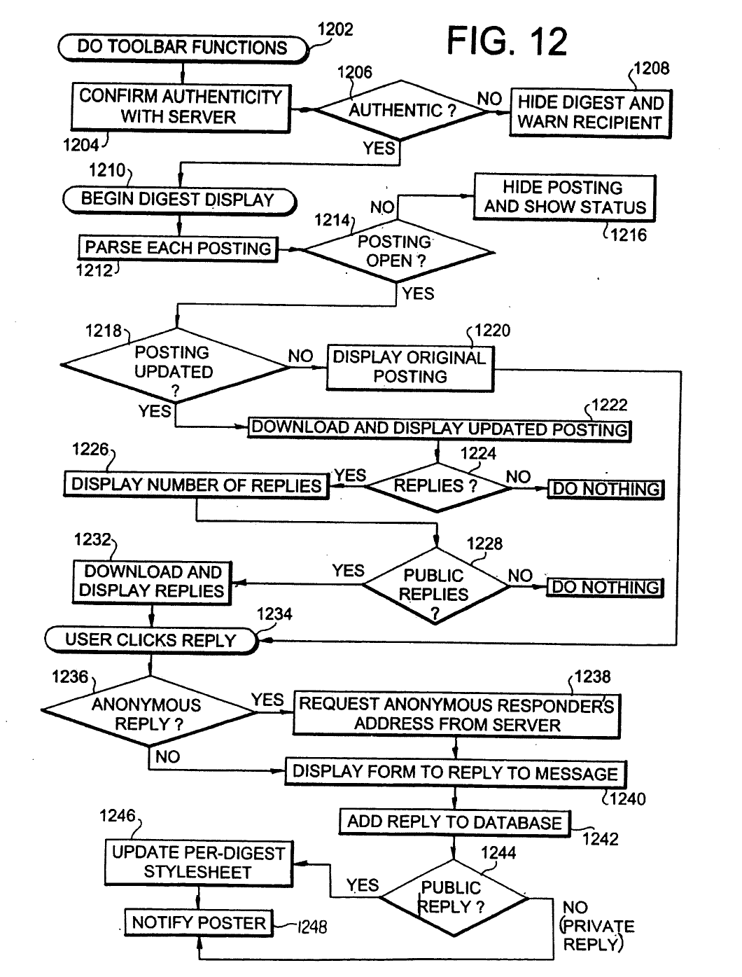

FIG. 13 is a process flow diagram depicting the process flow steps according to an embodiment of the present invention where the user clicks to reply to a message. When the user clicks to reply to a message 1300, if they have the toolbar extension 1302 the process would act as in FIG. 12 1304. A user without such an extension to their email client would effect the opening of a link in their browser displaying a reply form 1306. If there were existing replies to the message 1308 it would be advisable to display those replies 1310 to prevent the user from doing needless redundant work by repeating an answer. Then the system would display a form to collect the user's reply 1312. Upon submission of the form the reply would be stored in a database 1314. If the user allows their reply to be made public 1316, it can be added to the displayed replies for future users. If it is the first public reply, the per-digest stylesheet 1318 should be updated notifying those who open the mail digest that there is at least one reply to this message. The poster of the message will then be notified 1320 that a response has been made to the message.

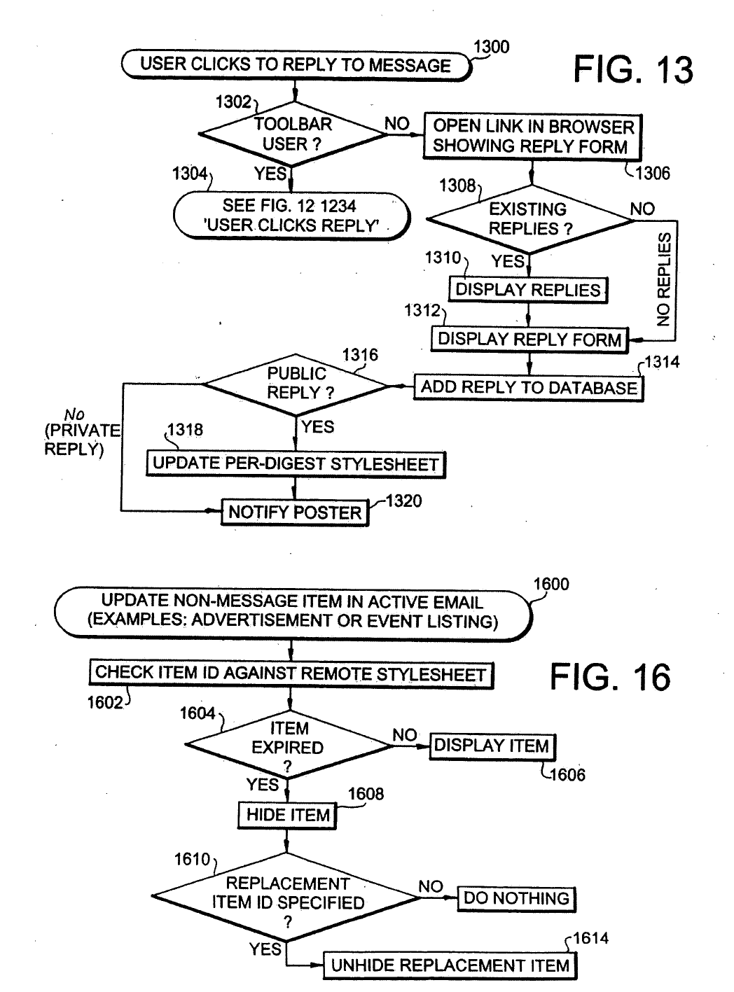

FIG. 14 and FIG. 14a are process flow diagrams depicting the steps according to an embodiment of the present invention where an email client would parse a mail digest 1400, taking into account the various stylesheets to update the digest. For each item 1460 in the digest, the per-digest stylesheet will dictate whether the item is open 1402. If the item is closed it will hide 1404 the item 1460 and unhide the status message 1406 for that item which informs the recipient that it is closed 1462. Then, for the item, the personal-stylesheet will over-rule all previous stylesheets. If in the personal stylesheet the recipient has dictated that all messages from the sender of this message should be hidden 1408, the system will hide 1410 the message by hiding the sender container 1464 and it will unhide 1412 the status message 1466 saying this sender has been hidden by the recipient.

Otherwise, for the item, if the personal stylesheet says to highlight messages from this sender 1414, the personal stylesheet will modify the style 1420 of the sender container 1464, and inform the user that they have requested to highlight messages from this sender by un-hiding 1418 the sender highlight note 1468. Modifying the style 1420 can include such things as changing colors, fonts, and sizes to make the posting more noticeable.

Then, if it is determined that the user has chosen to hide items from a category 1422, the system will follow the rules defined in his personal stylesheet and hide 1423 the message by hiding the category container 1470 and it will unhide 1424 the note 1472 reminding the user they have requested to hide messages in this category. Otherwise, if the personal stylesheet says to highlight messages in a category 1427 the system will unhide 1428 the note 1474 reminding the user that he has requested to highlight messages in this category, and it will follow the rules in the personal stylesheet to modify the style 1430 of the category container 1470.

If the global or per-digest stylesheets indicate that this message is featured or sponsored 1432, the system may unhide 1436 the note 1478 indicating that this is a sponsored message and may modify the styles 1438 of the sponsored message container 1476 for this message to signal to the recipient that this message is different from all others. Such a system enables moderators and service providers to highlight important messages, and accept sponsorships for fundraising or profit. Also, because the sponsorship can be defined in the remote per-digest stylesheet 1438, it can be modified after the digest is mailed, thus enabling sponsors to pay either for an amount of time or an amount of viewers. For example, they may pay only for the message to be highlighted until a certain date, or until 5000 people download the digest. If the message is not sponsored, the stylesheets do not modify 1434 the style of the sponsored container.

If the posting has been updated since it was compiled into this digest 1440, the per-digest stylesheet may unhide 1444 a note 1482 informing the user that there is an updated version of this posting available online and perhaps providing a direct link to the posting's page on the service provider's website.

If there have been one or more replies to this posting 1446, the system can unhide 1450 a note 1484 informing the recipient that there have been replies to this posting. This helps recipients avoid losing time providing answers that would only be redundant, and it lets viewers know that someone may have added additional useful information to the original posting since it was compiled. Without this functionality, users would only know about updates that happened before the digest was compiled and mailed, thus missing much of this information.

Additionally, some posters may not wish to receive replies to their posting. Sometimes they may know this before posting, however, the present invention enables them to change their mind 1452, even after the digest has been sent. The per-digest stylesheet can be updated at any time to hide 1456 or show 1454 response options 1488, such as ‘Reply’ or ‘Click to call.’ This can be useful for broadcast-type messages such as “school will be closed due to snow,” where the school administrator does not want to receive questions about that message from thousands of parents. This is also useful where the poster has received a useful answer and does not need further responses, but wishes to enable other recipients to see the question and benefit from the answers.

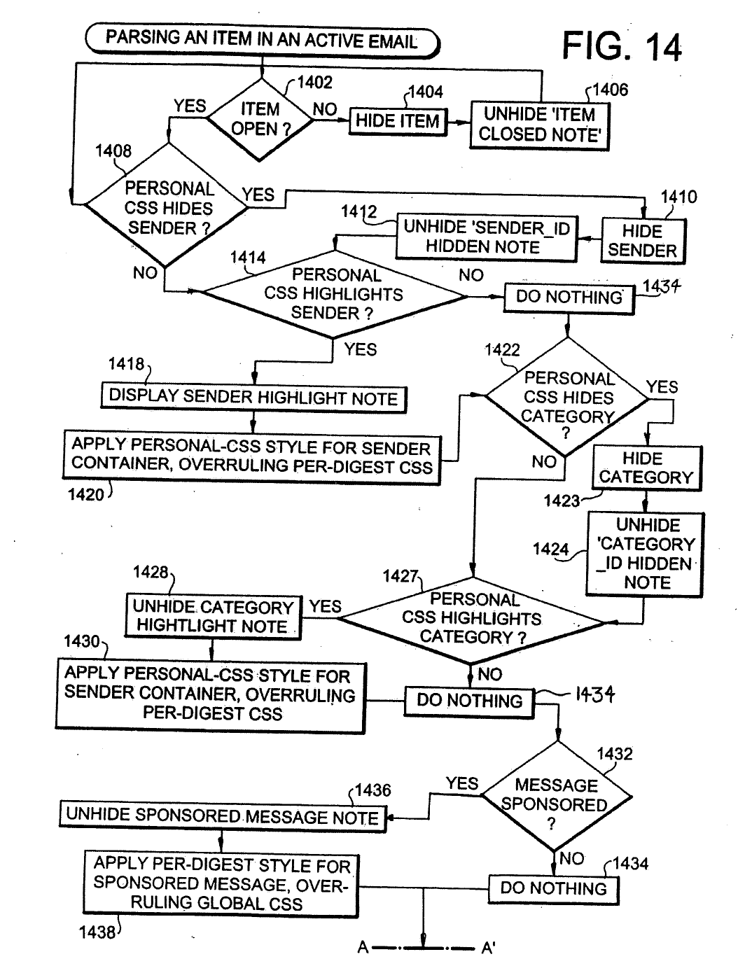

FIG. 15 is a process flow diagram depicting the steps according to an embodiment of the present invention where an email client would parse a single-notification email 1500. Such a message might be: “You have a new message on the website, click here to visit the website and read it.” However, if the recipient was on the website while that notification was sent to him, the recipient is likely to have read the message before seeing the notification, thus the notification is outdated and clicking its link would be redundant and useless. Thus, the notification email would call to a remote stylesheet 1501 which would indicate if the status of that notification email had changed. If it had changed 1502 it would unhide a status note 1504 which corresponds to the status of the email. For example, it might unhide a status note saying “You have already read or replied to this message. Click here to revisit it.” If the sender of the message, which may be an automatic system, thinks the original message should not be read, its container may be hidden 1506. Otherwise, if it thinks it should remain visible 1506 or the status has not been changed since it was sent 1502 the message remains unhidden 1508, visible to the recipient.

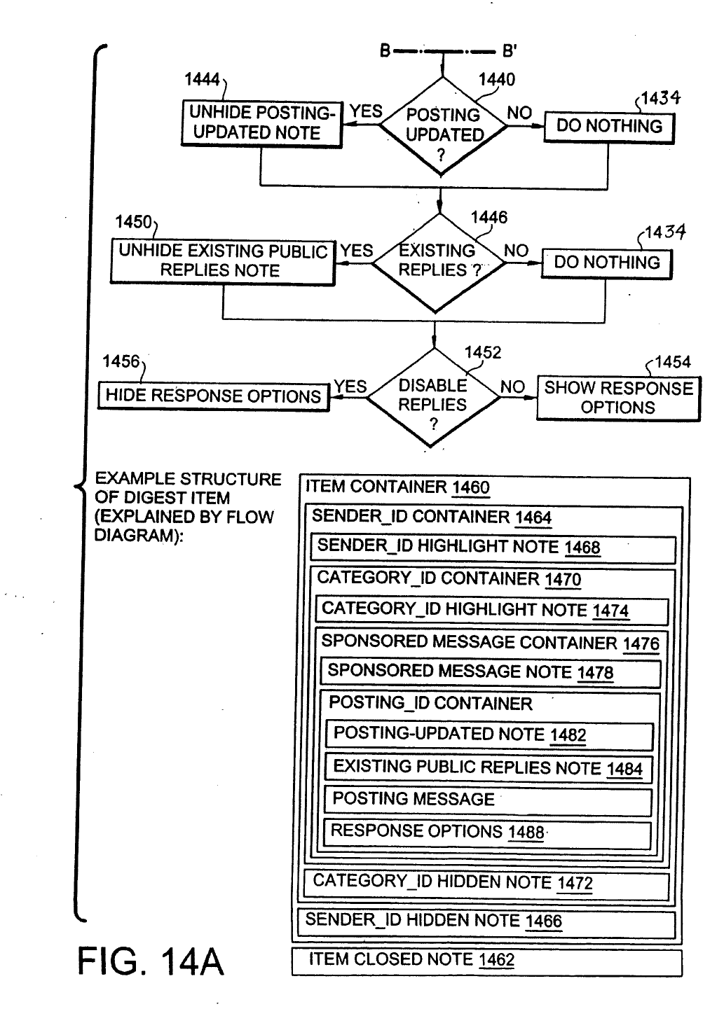

FIG. 16 is a process flow diagram depicting the steps according to an embodiment of the present invention where an email client would parse a non-message item 1600, such as an advertisement or event listing, in any email. The client, having called a remote stylesheet 1602 would follow the rules dictated for that item's style. If the item is not closed or expired 1604, the item would remain visible to the recipient 1606. If the item has expired, however, the stylesheet would hide the item 1608, setting its display property to hidden. This method would also enable systems to embed replacement items into the message 1610 and unhide them 1614 when the original item is hidden 1608. For example, a digest might display an advertisement at the top of the screen, and the advertiser may wish to pay only for the first 1000 recipients to view the advertisement, or may wish to hide the advertisement after a certain date. If the digest only hides that message it will make no more revenue. However, it can embed a hidden advertisement which will be made visible at the time the original advertisement is hidden.

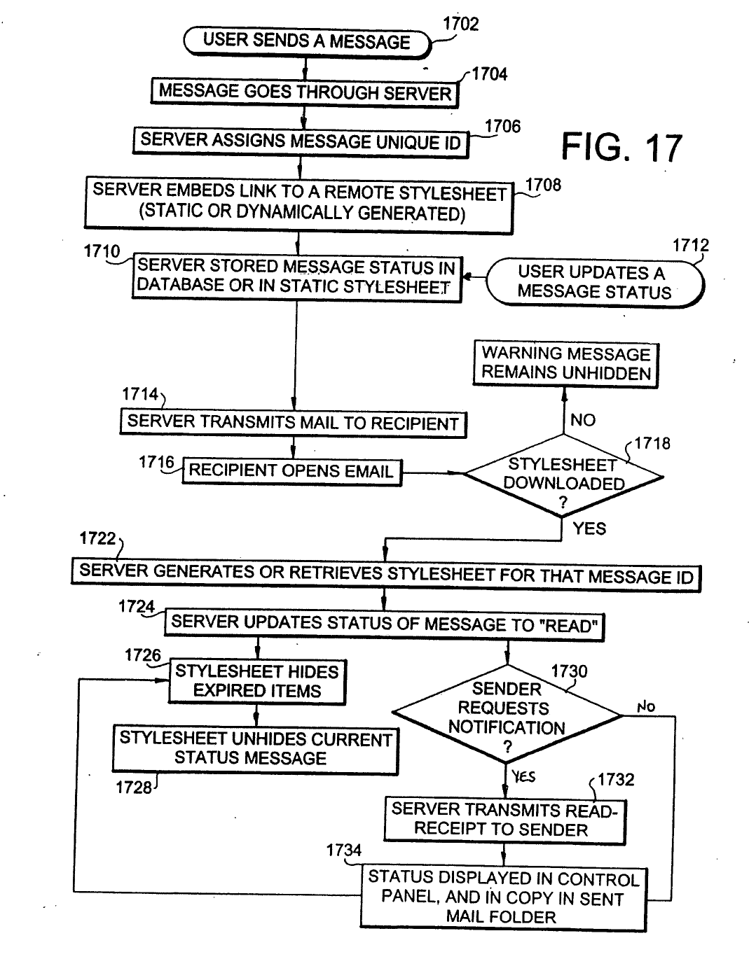

FIG. 17 is a process flow diagram depicting the steps according to an embodiment of the present invention where a customized mail server would enable one individual to send email to another individual and then update the status of the sent email. The user would send an email using their email client or a web-based control panel 1702. In either case, the message would go through the user's email server 1704. If the user is using an email client they would accomplish this by specifying it as their outgoing-mail or SMTP server. A modification to the server would assign the message a unique ID 1706. A link would then be embedded to a corresponding stylesheet or a stylesheet-generating script for that message ID 1708. The message and its status would then be indexed 1710 in a database or in a static stylesheet. Once the link is embedded into the email, the server can transmit the email to the recipient mail server 1714.

When the recipient downloads the message 1716 from their mail server, if their email client calls the sender's server to download the remote stylesheet 1718, the sending server will retrieve or generate a stylesheet for that message ID with the current status 1722. The sender's server can then mark the message as read 1724 by the email client. If the sender requested notification of when the recipient opens the email 1730, the sending server can send a message to the sender 1732. Unlike traditional read receipts which are sent by the recipient's server, and are at the mercy of that server, this notification is done by the sender's server, so the notification can be done via email, instant message, text message or an alert via their email client, or any method the sender prefers.

Regardless, if the stylesheet has been called, the status of the message is updated as read 1724 and the sender will see this status in their mail control panel 1734, and they may also see if their mail server saved a copy of the sent email in their Sent Mail folder, with a link to a dynamic stylesheet, just as with the mail sent to the recipient. Such status and notification functionality is useful today when many legitimate and important emails are accidently deleted or blocked by spam filters. If the sender sees that a message has not been opened, they may re-send it or contact the user by another means to ensure they receive important information.

If the sender updates the message status at any time, or if the recipient replies, the stylesheet can be modified, and the recipient will see the current status of the message 1728. Statuses might include “The sender says to disregard this message,” “The sender has sent an updated message which should appear in your inbox,” and “You have replied to this message.” If the sender feels the original message is no longer relevant they may choose to hide it 1726, so the recipient does not waste time reading it.

In all cases, it would be advisable to include standard HTML tags as well as header lines which instruct HTML parsers not to store the message and the linked stylesheets in cached memory, such as the HTML “no-cache” meta tag. While these tags are sometimes not honored by the parsers, they may ensure the email client opens current versions of all remote stylesheets and images each time the user refers to an email, thus always showing them the current statuses.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

I claim:

1. A method for dynamically changing a status of an item in a static email message, comprising the steps of:
storing in a database at a server a plurality of items received by a provider of an online service from a plurality of users of the online service, each of the items having a status indicating whether the item has been addressed by any of the users of the online service;
updating the status of the items in response to data communications received from users of the online service having permission to update the status;
creating an email message containing one or more items and a set of embedded instructions for retrieving from the server the status of the included items wherein the set of embedded instructions comprises a request for retrieving the status of the included items from the server is executed when the e-mail message is opened by one or more users of the online service; and
sending the email message to the one or more users of the online service.

2. The method according to claim 1, wherein the status is at least one of open, closed, featured, updated, urgent, public, replied and void.

3. The method according to claim 1, wherein the embedded instructions are one or more HTML calls to one or more remotely hosted stylesheets.

4. The method according to claim 1, wherein the embedded instructions are one or more HTML calls to one or more remotely hosted custom stylesheets.

5. The method according to claim 1, wherein the embedded instructions are one or more HTML calls to one or more remotely hosted images.

6. The method according to claim 1, wherein the embedded instructions are one or more HTML calls to one or more remotely hosted aliased images.

7. The method according to claim 1, wherein the online service is an online community website.

8. The method according to claim 1, wherein the online service is an email service provider.

9. The method according to claim 1, further comprising a client email toolbar extension.

10. A system for dynamically changing a static email message comprising:
one or more servers for maintaining an online service in, the one or more servers in data communications with one or more client computers of a plurality of users of the online service, the client computers adapted to enter and send a plurality of items to the servers and receive a plurality of emails from the servers;
a database for storing the plurality of items and a status associated with each of the plurality of items;
a status processing component for maintaining the status of the items in response to data communication received from the plurality of users; and
an email processing component for creating a plurality of email messages containing one or more items and sending the email messages to one or more of the plurality of users, the email messages containing a set of instructions for displaying on the client computers the current status of the one or more items contained in the email messages, the current status retrievable from the status processing component when the email messages are opened and the set of instructions is executed.

11. The system of claim 10, wherein the server comprises a web server for serving Internet web pages.

12. The system of claim 10, wherein the client computer includes an email client or access to an Internet-based email client.

13. The system of claim 10, wherein the one or more items are emails.

14. The system of claim 10, wherein the one or more items are message board postings.

15. The system of claim 10, wherein the set of instructions for displaying on the client computers the current status of the one or more items contained in the email messages as maintained by the status processing component is a call to a remotely hosted image file.

16. The system of claim 15, wherein the remotely hosted image is an aliased status image.

17. The system of claim 10, wherein the set of instructions for displaying on the client computers the current status of the one or more items contained in the email messages as maintained by the status processing component is a call to a remotely hosted stylesheet.

18. The system of claim 17, wherein the remotely hosted stylesheet is custom to the plurality of subscribers.

19. The system of claim 12, further comprising an email client extension software application adapted to recognize the plurality of email messages.

20. The system of claim 19, wherein the email client extension is adapted to display the current status of the one or more items contained in the email message.

21. The system of claim 19, wherein the email client extension is adapted to display a button for replying to the items contained in the email message.

22. A system for dynamically changing a static email message comprising:
a storage medium on a first server in data communications with one or more client computers, the storage medium containing computer code operable for:
storing in a database at a server a plurality of items received by a provider of an online service from a plurality of users of the online service, each of the items having a status indicating whether the item has been addressed by any of the users of the online service;
updating the status of the items in response to data communications received from users of the online service having permission to update the status;
creating an email message containing one or more items and embedded instructions, the embedded instructions for sending a request when the email message is opened to the server for the current status of the included items;
sending the email message to one or more users of the online service; and
sending to the one or more users of the online service, in response to the request, the current status of the included items.
